(19) United States
(12) Patent Application Publication
(10) Pub. No.: US 2009/0029578 A1
(43) Pub. Date: Jan. 29, 2009

(54) ELECTRICAL SOCKET WITH SAFETY COVER

(76) Inventor: Tung Yan Lau, Shatin (HK)

Correspondence Address: OSTROLENK FABER GERB & SOFFEN, 1180 AVENUE OF THE AMERICAS, NEW YORK, NY, 100368403, US

(21) Appl. No.: 12/057,803

(22) Filed: Mar. 28, 2008

Related U.S. Application Data
(60) Provisional application No. 60/951,739, filed on Jul. 25, 2007.
(60) Provisional application No. 60/980,868, filed on Oct. 18, 2007.

(51) Int. Cl. H01R 13/44

(52) U.S. Cl. 439/135

(57) ABSTRACT

An electrical socket that includes at least two electrical terminals each operatively engagable by a respective prong of an electrical plug by insertion into a respective opening of a housing of the electrical socket. A cover plate is provided to, in one position cover the openings of the housing and in another position expose the openings of the housing through corresponding apertures through the cover plate. The cover plate is mounted for slidable linear movement between the one position and another position relative the housing. There is a surface or surfaces presented by the cover plate non-parallel (and preferably lateral) to the direction of movement to abut a stop surface(s) of the housing that prevent advancement of the cover plate towards the another position when only one aperture is engaged by an object to move the cover plate by virtue of a non linear movement of the cover plate relative to said housing.

### CROSS-REFERENCE TO RELATED APPLICATIONS

This application claims priority to U.S. Provisional Application Nos. 60/951,739 and 60/980,868, filed Jul. 25, 2007 and Oct. 18, 2007, respectively, the disclosures of which have been incorporated herein by reference.

### FIELD OF THE INVENTION

The present invention relates to a safety cover for selective concealing of electrical socket openings and/or electrical sockets with a safety cover. In particular though not solely, the invention relates to a cover plate used in or of an electrical adaptor or socket such as a wall socket to prevent electrocution by incorrect use of the electrical socket.

### BACKGROUND

Cover plates used in electrical sockets are known. The cover plate includes openings which, in a biased position, are out of register with the electrical terminal openings of an electrical socket. Exposed openings pose a danger especially to toddlers or young children who may be unaware of the dangers inherent in inserting objects into openings. Primarily, a cover plate functions to conceal the openings when no plug is inserted into the electrical socket and is a safety feature to prevent inadvertent electrocution. To correctly insert an electrical plug into a socket, a user will typically shift the cover into a position where the cover plate openings are congruous with the openings, thereby allowing the pins of an electrical plug to be inserted into the openings.

While a typical cover plate serves its function of providing safety when used correctly, it may not prevent electrocution if used incorrectly. For example, if a user attempts to insert one pin of an electrical plug or other objects that could be inserted into one of the cover plate openings to effect movement of the cover plate, the cover plate may still be moved as when used correctly. This poses a potential danger to users in that one pin of a plug or an object that is inserted into one of the openings may cause electrocution.

It is therefore an object of the present invention to overcome the above problem and/or that will at least provide the public with a useful choice.

### BRIEF DESCRIPTION OF INVENTION

Accordingly in a first aspect the present invention consists in an electrical socket that includes at least two electrical terminals each operatively engagable by a respective prong of an electrical plug by insertion into a respective opening of a housing of the electrical socket, wherein a safety cover is provided, the safety cover movable between a primary covering position preventing insertion of an object into any of the openings of the housing and each of (a) a primary non covering position to present the openings to allow operative engagement of each electrical terminal and (b) a secondary covering position preventing insertion of an object into any of the openings of the housing and where the safety cover engages an interference surface of the housing preventing the movement of the safety cover to the primary non covering position.

Preferably, the safety cover is a cover plate that includes apertures placed in a configuration to each be contiguous a respective opening of the housing when the cover plate is in the primary non covering position to then allow the passing of respective prongs of an electrical plug through the apertures and into the openings of the housing for operative engagement with the electrical terminals.

Preferably, the safety cover is biased by a biasing means towards the primary covering position.

Preferably, the safety cover is a cover plate that blocks the openings of the housing when the cover plate is in the primary covering position and in the secondary covering position. Preferably, the safety cover is slidably movable relative the housing.

Preferably, the safety cover is adapted to be movable in a linear manner relative the housing by the prongs of an electrical plug when inserted into the apertures of the safety cover, and upon the application of a force by a person holding the electrical plug, between the primary covering position and the primary uncovering position.

Preferably, the safety cover is adapted to be movable in a rotational manner relative the housing.

Preferably, the safety cover is caused to move in a rotational manner by the application of a force by a person on the safety cover when attempting to insert an object into only one of the openings of the housing thereby moving the safety cover to a secondary covering position and preventing it from advancing to the primary non covering position.

Preferably, the safety cover is biased by a biasing means towards the primary covering position and wherein the biasing means is positioned such that when only one of the apertures receives an object which is then moved to attempt to move the safety cover to the primary non covering position, the safety cover moves towards the secondary covering position to then be prevented from further movement of the safety covet other than back to the primary coveting position.

Preferably, the secondary non covering position is a disposition of the safety cover relative the housing which is achieved without having moved to the primary non covering position from the primary covering position.

Preferably, the housing includes a recess at the plug receiving face of the housing in which the safety cover is located, and wherein the safety cover includes
a. a primary covering position stop to interact with a stop surface of the housing to thereby stop movement of the safety cover in the recess at the primary covering position,
b. a primary non covering position stop to interact with a stop surface of the housing to thereby stop the movement of the safety cover at the primary non covering position of the safety cover, and
c. a secondary covering position stop to interact with a stop surface of the housing to thereby stop the movement of the safety covet at the primary non covering position of the safety cover.

Preferably, the safety cover is located in the recess in a manner to sit flush with the plug receiving face of the housing.

Preferably, the stops are perimeter surfaces of the safety cover.

Preferably, the or each surface of the housing is defined by perimeter surfaces of the recess.

Preferably, the stops are perimeter surfaces of the safety cover presented in a direction non-parallel (and preferably lateral) to the direction of force from a biasing means acting on the safety cover.

Preferably, the surface stops are perimeter surfaces of the safety cover.

Preferably, the primary non covering position stop and secondary covering position stop are positioned to allow the secondary covering position stop to move past its related stop surface when the safety cover is moved in an out-of-register orientation from its primary coveting position with the secondary coveting position stop to the primary non covering position.

Preferably, the recess is of size to allow rotation of the safety cover about an axis non parallel to the direction of the force applied to the safety cover by the biasing means. Preferably, the axis is normal to the plane of the cover.

Preferably, the housing includes a recess at the plug receiving face of the housing in which the safety cover is located, and wherein the safety cover includes
d. a primary coveting position stop to interact with a stop surface of the housing to thereby stop movement of the safety cover in the recess at the primary covering position,
e. at least one castellation defined at a perimeter of the safety cover that is of a complementary shape to a perimeter region of the recess and into which the castellation can nest when the safety cover is moved to the primary non covering position wherein the nesting is prevented and movement to the primary non covering position can thereby not be achieved when the safety cover is rotated relative the housing.

Preferably, at least one castellation becomes mis-aligned with the complementary shape upon the application of an unbalanced force on the safety cover that is in a direction opposite to the direction in which the force of a biasing means acts on the safety cover plate and which causes the cover plate to rotate.

Preferably, an electrical socket forms part of a universal adaptor.

Accordingly, in another aspect the invention consists of an electrical socket that includes at least two electrical terminals each operatively engagable by a respective prong of an electrical plug by insertion into a respective opening of a housing of the electrical socket, wherein a safety cover is provided that is movably mounted to the housing in a translational and rotational manner and that includes apertures placed in a configuration to each be contiguous a respective opening of the housing when the cover plate is in a primary non covering position relative the housing to then allow the passing of respective prongs of an electrical plug through the apertures and into the openings of the housing for operative engagement with the electrical terminals, the safety cover movable between a primary covering position covering the openings of the housing to thereby preventing insertion of an object into any of the openings of the housing and each of (a) a primary non covering position wherein the apertures are contiguous the openings to present the openings to allow operative engagement of each electrical terminal and (b) a secondary covering position covering the openings of the housing to thereby prevent insertion of an object into any of the openings of the housing and where the safety cover engages an interference surface of the housing preventing the movement of the safety cover to the primary non covering position, wherein the safety cover is biased by a biasing means to the primary covering position, wherein the safety cover is caused to move in a rotational manner relative the housing by the application of a force by a person on the safety cover when attempting to insert an object into only one of the openings of the housing thereby moving the safety cover to the secondary covering position preventing it from advancing to the primary non covering.

Accordingly, in another aspect the invention consists of an electrical socket that includes at least two electrical terminals each operatively engagable by a respective prong of an electrical plug by insertion into a respective opening of a housing of the electrical socket, a cover plate to, in one position cover the openings of the housing and in another position expose the openings of the housing through corresponding apertures through the cover plate and which is mounted for slidable linear movement between the one position and another position relative the housing and where there is a surface or surfaces presented by the cover plate non-parallel (and preferably lateral) to the direction of movement to abut a stop surface(s) of the housing that prevent advancement of the cover plate towards the another position when only one aperture is engaged by an object to move the cover plate by virtue of a non linear movement of the cover plate relative to said housing.

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.

As used herein the term “and/or” means “and” or “or”, or both.

As used herein “(s)” following a noun means the plural and/or singular forms of the noun.

The term “comprising” as used in this specification means “consisting at least in part of”. When interpreting statements in this specification which include that term, the features, prefaced by that term in each statement, all need to be present but other features can also be present. Related terms such as “comprise” and “comprised” are to be interpreted in the same manner.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

### BRIEF DESCRIPTION OF DRAWINGS

FIG. 1 is a perspective view of an adaptor that includes a safety cover in a primary covering position,

FIG. 2 shows the adaptor as shown in FIG. 1 wherein the cover plate has moved to a primary non-convering position to allow the insertion of pins of an electrical plug into the adaptor,

FIGS. 3a and 3b are perspective views showing how an electrical plug is correctly inserted into the adaptor,

FIGS. 4a and 4b are plan views of the adaptor that shows the movement of the cover plate from a primary covering position to a primary non-covering position,

FIGS. 5a and 5b are side views of how an electrical plug is correctly inserted into the adaptor,

FIGS. 6a and 6b are perspective views showing how one pin of an electrical plug may be inserted into the adaptor,

FIGS. 7a and 7b are plan views of the adaptor that shows the movement of the cover plate from a primary covering position towards a primary non-covering position and into a secondary covering position,

FIGS. 8a and 8b are side views of how an electrical plug may be incorrectly attempted to be inserted into the adaptor using only one pin of the electrical plug,

FIGS. 9a and 9b are plan views of an electrical socket illustrating an embodiment of a safety cover plate moving from a primary covering position towards a secondary covering position when only one pin is attempted to be inserted,

FIG. 10 is a plan view of an electrical socket illustrating an embodiment of a cover plate moved from a primary covering position to a primary non-coveting position, and

FIGS. 11a and 11b are plan views of an electrical socket illustrating an embodiment of a cover plate moving from a primary covering position towards a secondary covering position when only one pin is attempted to be inserted, and

FIG. 12 is a plan view of the adaptor illustrating an embodiment of a cover plate moving from a primary covering position to a primary non-covering position.

### DETAILED DESCRIPTION

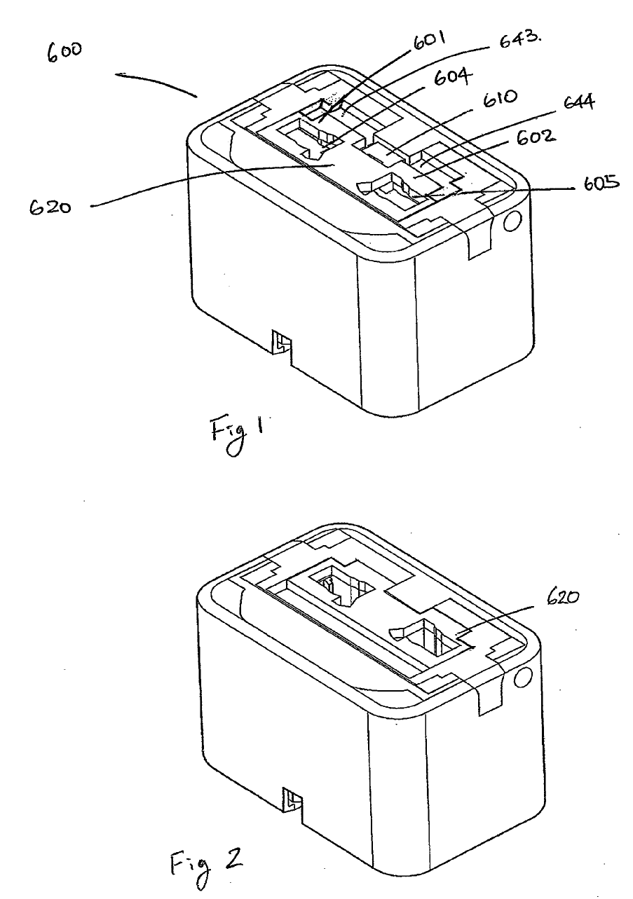

With reference to FIGS. 1 and 2 there is shown a cover plate being part of an adaptor 600. The adaptor 600 is of a kind that may also be known as a universal adaptor or multi adaptor or travel adaptor or similar. While reference herein is made to a cover plate as part of an adaptor, the cover plate can be part of any electrical socket, power outlet, power receptacle or the like. It has particular application for adaptors, where a misuse of an electrical plug could otherwise cause electrocution, because of the shape of the body or housing of the adaptor. Where reference herein is made to an electrical socket, it may mean something into which for example an electrical plug is commonly inserted. Such an electrical socket may include at least two terminals, one live and one neutral terminal, and may also include an earth terminal. The invention is also suitable in or for wall sockets where the prospect of only one pin of an electrical plug being inserted is possible or where there is a prospect of any object being inserted such as a screwdriver.

The most common types of electrical plugs that are catered for by adaptors include:

a) the North American two-pin plug (comprising of flat parallel blades),

b) the European two-pin plug (round pins with a plastic or rubber pin base, and also commonly known as the “Europlug”),

c) the British three-pin plug comprising of rectangular blades, two of which are circuit blades and one of which may be an earth blade or dummy blade that also serves the purpose of actuating any socket connection restrictors upon the insertion of the plug into a corresponding socket, and

d) the Australian two-pin plug (comprising of oblique blades).

An adaptor can allow for one (or multiple) type of electrical plug to be utilised with one (or multiple) electrical wall socket of another type. FIG. 1 shown an example of an adaptor from the electrical plug receiving side.

Where reference herein is made to electrical plugs it is to be understood to mean plugs of the above type that are known and that include features as generally described above and it may also mean something that includes at least two pins forming electrical terminals that can be inserted into the terminals of an electrical socket or adaptor.

FIGS. 1 and 2 are perspective views of an adaptor that includes a cover plate in a primary covering position and a primary non-covering position respectively. The cover plate 620 includes openings 604, 605 that correspond to the openings of the body 660 of the adaptor below which are electrical terminals to receive pins of an electrical plug. There could be just one opening in the cover that is of a size and shape to allow it to uncover each terminal. The cover plate may be supported by the adaptor body 660 in a sliding manner and also in a rotational manner. The cover plate is movable between two positions. In a first primary covering position, the openings 604 and 605 of the cover plate 620 are out of register with the underlying openings of the body 660. This is shown in FIG. 1.

FIG. 2 shows the adaptor as shown in FIG. 1 wherein the cover plate has moved to allow the insertion of an electrical plug into the adaptor. Here the cover plate 620 presents its openings 604 and 605 in a primary non-covering position relative the underlying openings of the body 660. This is the second position.

The cover plate 620 includes two projections 601, 602 adjacent the openings 604, 605 of the cover plate. The projections 601, 602 are slidable into their complementary recesses 643, 644. The cover plate may be acted upon by a biasing means 610. This may be placed in between the projections 601, 602 to bias the cover plate to the out of register (first primary covering position) condition. Alternatively, the biasing means may be placed in each of the recesses 604, 602 complementary to the projections 601, 602 of the cover plate (shown in FIGS. 9-12). The biasing means may be in the form of a spring, a helical coiled spring, leaf spring, or any other resilient means.

A person wanting to insert an electrical plug needs to move the cover plate against the bias in order to insert the plug into the electrical terminals.

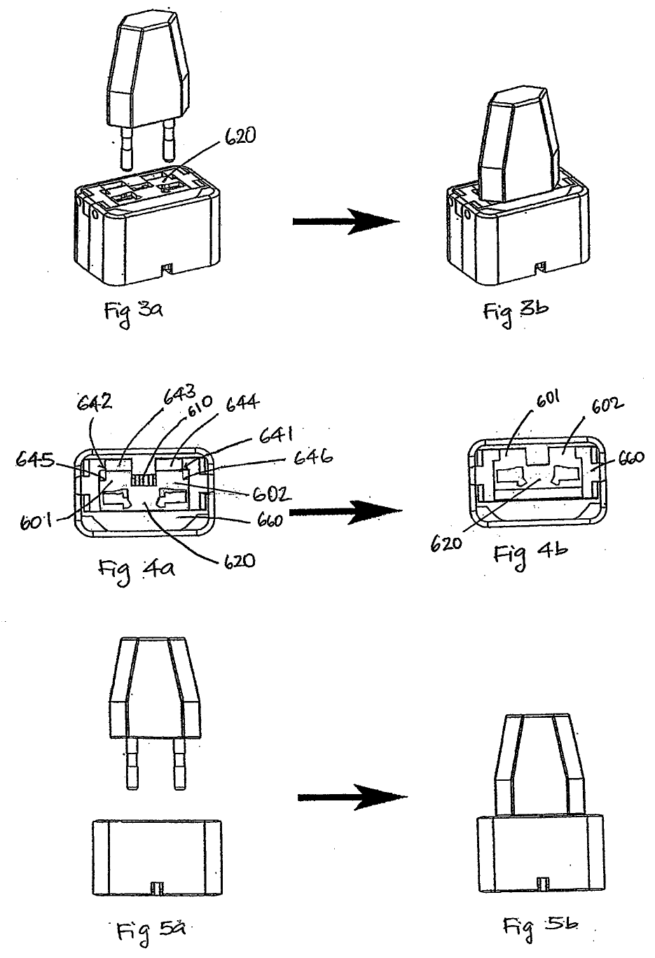

FIGS. 3 and 4 show a preferred form of the embodiment of the cover plate 620. The adaptor body includes two recesses 643, 644 for receiving two projections 602, 601 of the cover plate, from which two corners 645, 646 have been cut out. The shape of the cover plate 620 is such that the corners 645, 646 complement recesses 643, 644 respectively.

FIGS. 3-5 illustrate how an electrical plug is normally inserted into the adaptor body via the cover plate. FIG. 3a shows an electrical plug that is about to be inserted into an adaptor body where the cover plate 620 is in a primary covering position. In order to shift the cover plate into a primary non-covering position to enable the electrical plug to be inserted into the terminals of the adaptor body, the two pins of the electrical plug may simultaneously be partially inserted into the cover plate 620 and pushed against a wall of each opening of the cover plate 620. The force exerted at each opening by the two pins can be substantially equal. This will cause the movement of the cover plate into an in-register position. This enables the pins to then be fully inserted into the exposed terminals of the adaptor. The force applied by the user, via the plug can be adjusted to manipulate the rotational orientation of the cover plate. This may be require uneven application of force on each pin such as for example if the spring is located off centre. It will hence be appreciated that the spring biases the cover plate to the primary covering position and the user can press against this force appropriately via the plug. By virtue of at least two pins being engaged in the apertures of the cover plate, a rotational displacement of the cover plate can be effected thereby along the control of the position of the cover plate to let it be displaced to the primary non covering position.

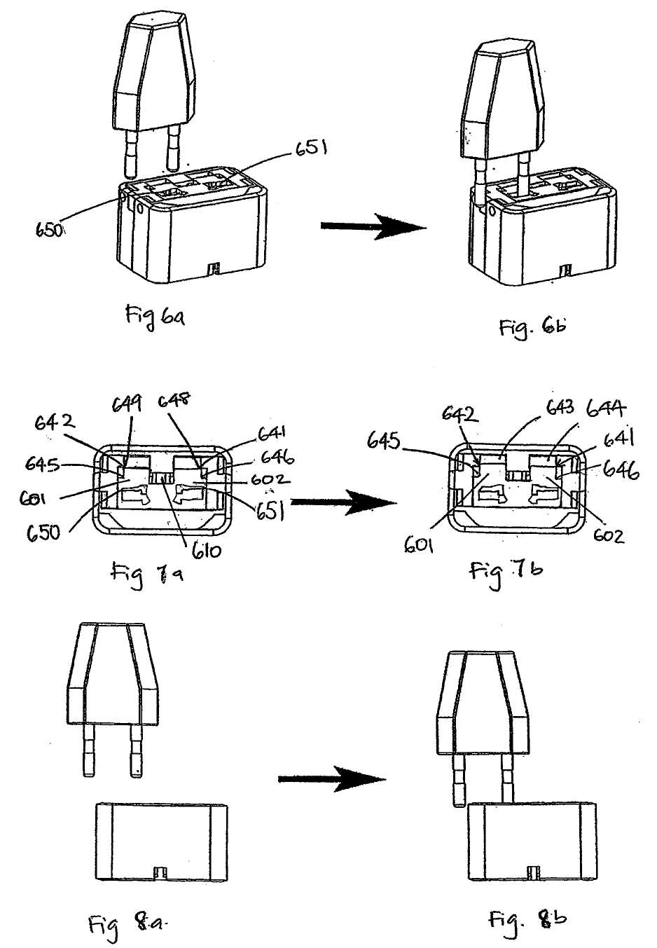

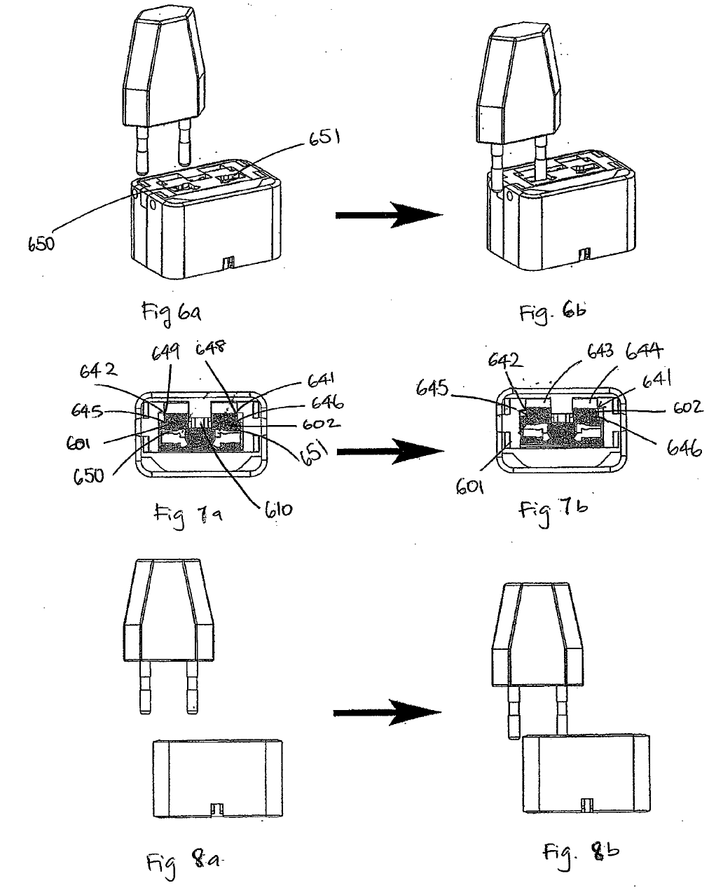

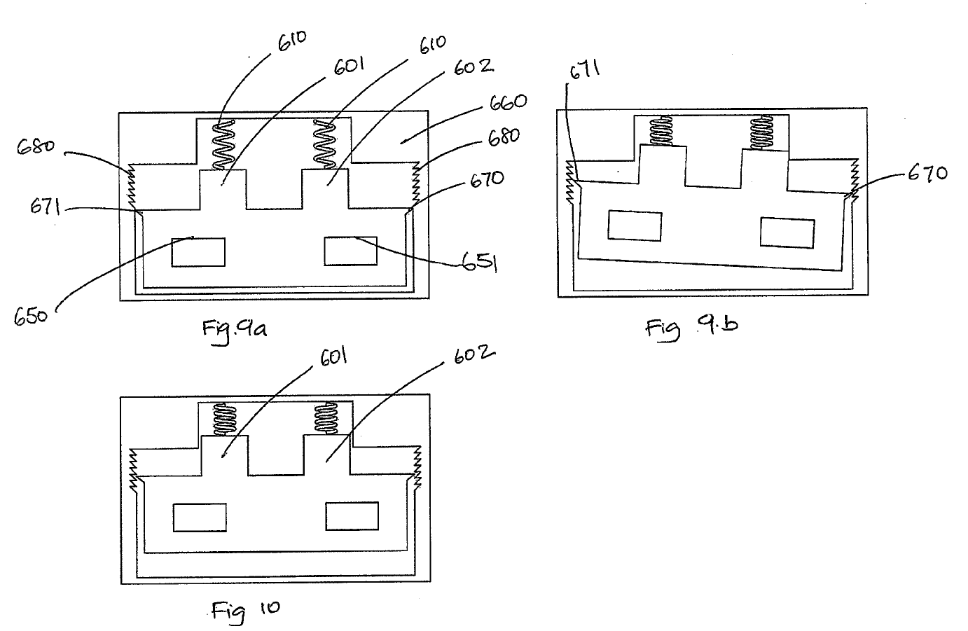

FIGS. 6-8 illustrate how electrocution of a user, for example a toddler or a young child, can be prevented when only one pin of an electrical plug is used to attempt movement of the cover plate from a primary covering position to a primary non-covering position. When any pin of an electrical plug is inserted into one of the openings of the covet plate 620, a user may attempt to effect movement of the cover plate into a primary non-covering position by pushing that pin against the inner wall (650 or 651) of one of the openings. For example, since force is only exerted on the inner wall of one of the openings of the cover plate, this causes one side of the cover plate to tilt. FIG. 7a illustrates an example of a user attempting to insert a pin into the cover plate opening 650 (pin not shown). By effecting movement of the cover plate through force exerted on the inner wall 650, this shifts the cover plate 620 such that the corner 641 of the recess 644 prevents the corresponding corner 648 of the cover plate from moving into the recess 644. This prevents the movement of the cover plate into the primary non-covering position and prevents the user from inserting the pin into an electrical terminal of the body. The cover plate instead moves into a secondary covering position. Then only one opening of the cover plate is engaged, there is no control over the rotational orientation of the covet plate. This hence means that the spring can effect a rotation on the cover plate as it is attempted to be linearly displaced. Such rotation will result in the cover plate being prevented in its movement from the primary covering position to the primary non covering position.

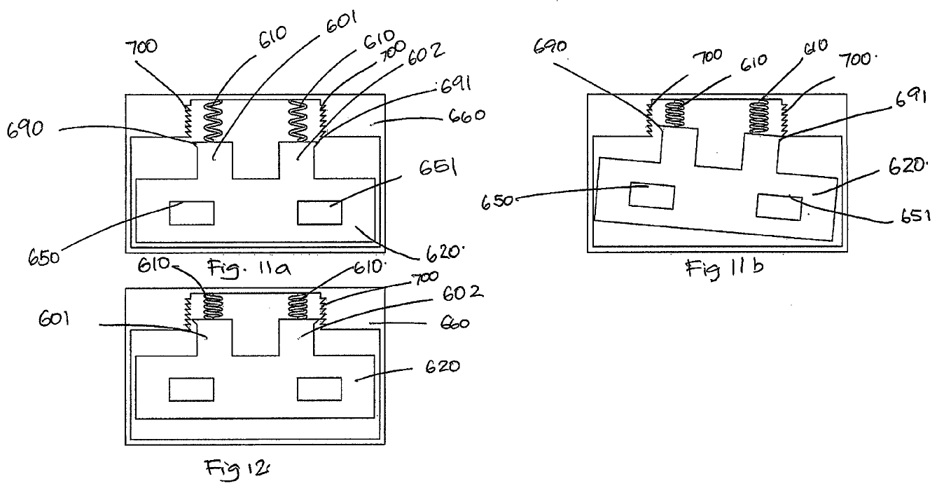

In another preferred form of the embodiment of the cover plate shown in FIGS. 9 and 10, the cover plate includes biasing means on each of the corresponding projections 601, 602. The biasing means 610 urge the cover plate to a primary non-covering position. Although the adaptor body 660 as shown does not include the complementary recesses for the projections of the cover plate, it is envisaged that such an embodiment of the adaptor body 660 is also possible. FIGS. 9 and 10 show a cover plate which consists of a flanged portion 670, 671 on the outer sides in line with the path of travel of the cover plate into the in-register position. Along the path of travel of the cover plate to the primary non-covering, serrated edges 680 are lined on both sides of the supporting body such that the serrated edges provide resistance to the flanged portions 670, 671 of the cover plate. A user attempting to insert both pins of an electrical plug into the adaptor by inserting the two pins and simultaneously pushing against the inner walls 650, 651 of the cover plate openings towards the primary non-covering position will find minimal resistance to the path of travel as an equal force is applied to both inner walls. This results in the cover plate moving in a substantially linear manner towards the primary non-covering condition (not shown in figures).

However, if a user inserts one pin into either of the openings of the cover plate in an attempt to move the cover plate to the primary non-covering position, the unequal force distribution on the inner wall of one opening (shown in FIGS. 9a and 9b, as an example) of the cover plate will cause the cover plate to tilt sideways, causing the flanged portion 670 on the opposing side of the cover plate to be resisted by the serrated edges 680 of the supporting body. Although one side of the cover plate remains anchored due to the resistance of the serrated edges, the side of the cover plate opening which the pin is inserted continues to travel sideways till it reaches a point where the flanged portion 671 contacts the supporting body. When this happens, the cover plate remains stuck in a secondary covering position and is unable to move to the primary non-covering position.

FIGS. 11 and 12 illustrate another preferred embodiment. The projections 601 and 602 include a flanged portion 690, 691 at each corner facing the sides of the complementary recess of the adaptor body. Along the sides of the recesses proximal to the flanged portions 690, 691 of the cover plate are serrated edges 700 to provide resistance to the flanged portions of the cover plate. FIGS. 11a and 11b provide for an instance where one pin of the plug is used to attempt to cause movement of the cover plate before the projections 601, 602 enter the complementary recess of the adaptor body 660. In this instance, the cover plate 620 is tilted sideways when an unequal force distribution on one of the openings (650 in FIG. 11b) occur. The opposing flanged portion 691 of the cover plate is prevented from entering the recess of the adaptor body when it contacts one of the corners of the adaptor body. While movement of the cover plate is still possible in this position when force is continually exerted on the opening 650, the cover plate will never move to the primary non-covering position.

1. An electrical socket that includes at least two electrical terminals each operatively engagable by a respective prong of an electrical plug by insertion into a respective opening of a housing of the electrical socket, wherein a safety cover is provided, the safety cover movable between a primary covering position preventing insertion of an object into any of the openings of the housing and each of (a) a primary non covering position to present the openings to allow operative engagement of each electrical terminal and (b) a secondary covering position preventing insertion of an object into any of the openings of the housing and where the safety cover engages an interference surface of the housing preventing the movement of the safety cover to the primary non covering position.

2. An electrical socket as claimed in claim 1 wherein the safety cover is a cover plate that includes apertures placed in a configuration to each be contiguous a respective opening of the housing when the cover plate is in the primary non covering position to then allow the passing of respective prongs of an electrical plug through the apertures and into the openings of the housing for operative engagement with the electrical terminals.

3. An electrical socket as claimed in claim 1 wherein the safety cover is biased by a biasing means towards the primary covering position.

4. An electrical socket as claimed in claim 1 wherein the safety cover is a cover plate that blocks the openings of the housing when the cover plate is in the primary covering position and in the secondary covering position.

5. An electrical socket as claimed in claim 1 wherein the safety cover is slidably movable relative the housing.

6. An electrical socket as claimed in claim 2 wherein the safety cover is adapted to be movable in a linear manner relative the housing by the prongs of an electrical plug when inserted into the apertures of the safety cover, and upon the application of a force by a person holding the electrical plug, between the primary covering position and the primary uncovering position.

7. An electrical socket as claimed in claim 1 wherein the safety cover is adapted to be movable in a rotational manner relative the housing.

8. An electrical socket as claimed in claim 7 wherein the safety cover is caused to move in a rotational manner by the application of a force by a person on the safety cover when attempting to insert an object into only one of the openings of the housing thereby moving the safety cover to the secondary covering position and preventing it from advancing to the primary non covering position.

9. An electrical socket as claimed in claim 1 wherein the safety cover is biased by a biasing means towards the primary covering position and wherein the biasing means is positioned such that when only one of the apertures receives an object which is then moved to attempt to move the safety cover to the primary non covering position, the safety cover moves towards the secondary covering position to then be prevented from movement to the primary un covering position.

10. An electrical socket as claimed in claim 1 wherein the secondary non covering position is a disposition of the safety cover relative the housing which is achieved without having moved to the primary non covering position from the primary covering position.

11. An electrical socket as claimed in claim 1 wherein the housing includes a recess at the plug receiving face of the housing in which the safety cover is located, and wherein the safety cover includes
a. a primary covering position stop to interact with a stop surface of the housing to thereby stop movement of the safety cover in the recess at the primary covering position,
b. a primary non covering position stop to interact with a stop surface of the housing to thereby stop the movement of the safety cover at the primary non covering position of the safety cover, and
c. a secondary covering position stop to interact with a stop surface of the housing to thereby stop the movement of the safety cover at the primary non covering position of the safety cover.

12. An electrical socket as claimed in claim 11 wherein the safety cover is located in the recess in a manner to sit flush with the plug receiving face of the housing.

13. An electrical socket as claimed in claim 11 wherein the stops are perimeter surfaces of the safety cover.

14. An electrical socket as claimed in claim 11 wherein the or each surface of the housing is defined by perimeter surfaces of the recess.

15. An electrical socket as claimed in claim 11 wherein the stops are perimeter surfaces of the safety cover presented in a direction non-parallel (and preferably lateral) to the direction of force from a biasing means acting on the safety cover.

16. An electrical socket as claimed in claim 11 wherein the surface stops are perimeter surfaces of the safety cover.

17. An electrical socket as claimed in claim 11 wherein the primary non covering position stop and secondary covering position stop are positioned to allow the secondary covering position stop to move past its related stop surface when the safety cover is moved in an out-of-register orientation from its primary coveting position with the secondary covering position stop to the primary non covering position.

18. An electrical socket as claimed in claim 11 wherein the recess is of size to allow rotation of the safety cover about an axis non parallel to the direction of the force applied to the safety cover by the biasing means.

19. An electrical socket as claimed in claim 18 wherein the axis is normal to the plane of the cover.

20. An electrical socket as claimed in claim 1 wherein the housing includes a recess at the plug receiving face of the housing in which the safety cover is located, and wherein the safety cover includes
a. a primary covering position stop to interact with a stop surface of the housing to thereby stop movement of the safety cover in the recess at the primary covering position,
b. at least one castellation defined at a perimeter of the safety cover that is of a complementary shape to a perimeter region of the recess and into which the castellation can nest when the safety cover is moved to the primary non covering position wherein the nesting is prevented and movement to the primary non covering position can thereby not be achieved when the safety cover is rotated relative the housing.

21. An electrical socket as claimed in claim 18 wherein the at least one castellation becomes mis-aligned with the complementary shape upon the application of an unbalanced force on the safety cover that is in a direction opposite to the direction in which the force of a biasing means acts on the safety cover plate and which causes the cover plate to rotate.

22. An electrical socket as claimed in claim 1 forming part of a universal adaptor.

23. An electrical socket that includes at least two electrical terminals each operatively engagable by a respective prong of an electrical plug by insertion into a respective opening of a housing of the electrical socket, wherein a safety cover is provided that is movably mounted to the housing in a translational and rotational manner and that includes apertures placed in a configuration to each be contiguous a respective opening of the housing when the cover plate is in a primary non coveting position relative the housing to then allow the passing of respective prongs of an electrical plug through the apertures and into the openings of the housing for operative engagement with the electrical terminals, the safety cover movable between a primary covering position covering the openings of the housing to thereby preventing insertion of an object into any of the openings of the housing and each of (a) a primary non covering position wherein the apertures are contiguous the openings to present the openings to allow operative engagement of each electrical terminal and (b) a secondary covering position covering the openings of the housing to thereby prevent insertion of an object into any of the openings of the housing and where the safety cover engages an interference surface of the housing preventing the movement of the safety cover to the primary non covering position, wherein the safety cover is biased by a biasing means to the primary covering position, wherein the safety cover is caused to move in a rotational manner relative the housing by the application of a force by a person on the safety cover when attempting to insert an object into only one of the openings of the housing thereby moving the safety cover to the secondary covering position preventing it from advancing to the primary non covering.

24. An electrical socket that includes at least two electrical terminals each operatively engagable by a respective prong of an electrical plug by insertion into a respective opening of a housing of the electrical socket, a cover plate to, in one position cover the openings of the housing and in another position expose the openings of the housing through corresponding apertures through the cover plate and which is mounted for slidable linear movement between the one position and another position relative the housing and where there is a surface or surfaces presented by the cover plate non-parallel (and preferably lateral) to the direction of movement to abut a stop surface(s) of the housing that prevent advancement of the cover plate towards the another position when only one aperture is engaged by an object to move the cover plate by virtue of a non linear movement of the cover plate relative to said housing.
